(19) United States
(12) Patent Application Publication
(10) Pub. No.: US 2020/0103610 A1
(43) Pub. Date: Apr. 2, 2020

(54) COMMUNICATION CONDUIT SYSTEM

(71) Applicant: SAN DIEGO COUNTY WATER AUTHORITY, San Diego, CA (US)

(72) Inventors: Hiram Glenn THORPE, San Diego, CA (US); Martin Robert COGHILL, San Diego, CA (US); James Edward FISHER, San Diego, CA (US); Colin David KEMPER, San Diego, CA (US); Brent James FOUNTAIN, San Diego, CA (US)

(21) Appl. No.: 16/581,663

(22) Filed: Sep. 24, 2019

Related U.S. Application Data
(60) Provisional application No. 62/738,164, filed on Sep. 28, 2018.

(51) Int. Cl. G02B 6/50; F17D 1/08; F17D 1/02

(52) U.S. Cl. CPC G02B 6/502; F17D 1/02; F17D 1/08

(57) ABSTRACT

The present disclosure describes an outer utility pipe having a first diameter. In a first embodiment, the present disclosure describes an inner liner having a second diameter. The second diameter is smaller than the first diameter. The inner liner is positioned inside the outer utility pipe such than an annular space is created between the inner liner and the outer utility pipe. The inner liner is configured to conduct fluid. The present disclosure describes a communication conduit positioned in the annular space between the inner liner and the outer utility pipe. The communication conduit is configured to receive one or more components, such as fiber optic cables, configured to transmit information. In a second embodiment without an inner liner or an annular space, the communication conduit is received by a channel cut in an inner diameter surface of the outer utility pipe.

### RELATED APPLICATIONS

This application claims priority under 35 U.S.C. § 119(e) from provisional U.S. patent application No. 62/738,164 filed on Sep. 28, 2018, the contents of which are expressly incorporated herein by reference.

### BACKGROUND OF THE INVENTION

### Field of the Invention

The present disclosure relates to a system configured to facilitate transmission of information through below ground utility pipes.

### Description of Related Art

Underground utility pipes are known. Extensive networks of underground utility pipes exist under and between most cities. These pipes typically transport fluid including liquid, gas, and other fluids. Underground utility pipes are often dedicated to transporting liquid or gas, and are not configured for any other purpose.

### SUMMARY OF EMBODIMENTS OF THE INVENTION

One aspect of the present disclosure relates to a system configured to facilitate transmission of information through below ground utility pipes. The system may comprise an outer utility pipe having a first diameter. The outer utility pipe may be configured to be below ground. The system may comprise an inner liner having a second diameter. The second diameter may be smaller than the first diameter. The inner liner may be positioned inside the outer utility pipe such than an annular space is created between the inner liner and the outer utility pipe. The inner liner may be configured to conduct fluid. The system may comprise a communication conduit positioned in the annular space between the inner liner and the outer utility pipe. The communication conduit may be configured to receive one or more components configured to transmit information. In some embodiments, the one or more components the communication conduit is configured to receive may comprise a fiber optic cable or other components. In some embodiments, the outer utility pipe may be formed from steel or concrete or iron or plastic and the inner liner may be formed from steel or concrete or plastic, for example.

In some embodiments, the communication conduit may be coupled to an inner diameter of the outer utility pipe at a plurality of locations along a length of the outer utility pipe in the annular space. The communication conduit may be coupled to the inner diameter of the outer utility pipe using an anchor driven into a wall thickness of the outer utility pipe and a strap at individual locations along the length of the outer utility pipe. The communication conduit may be coupled to the inner diameter of the outer utility pipe at a radial position located toward a ground surface when the outer utility pipe is below ground.

In some embodiments, the annular space may be filled with cementious filler material and/or other filler material.

The outer utility pipe, the inner liner, and the communication conduit may be configured to couple with corresponding utility pipes, inner liners, and communication conduits to facilitate extended transmission of information through below ground utility pipes. In some embodiments, the communication conduit may comprise fittings at both ends configured to facilitate removable coupling of the communication conduit with additional communication conduits and substantial sealing of the communication conduit to prevent ingress of earthen materials. In some embodiments, the outer utility pipe may comprise a port configured to allow at least a portion of the communication conduit to pass through and out toward a ground surface.

A second aspect of the present disclosure relates to a method for facilitating transmission of information through below ground utility pipes. The method may comprise providing an outer utility pipe having a first diameter. The outer utility pipe may be buried below ground. The method may comprise positioning a communication conduit inside (and/or within a wall of) the outer utility pipe. The method may comprise positioning an inner liner inside the outer utility pipe. The inner liner may have a second diameter. The second diameter may be smaller than the first diameter. The inner liner may be positioned inside the outer utility pipe such than an annular space may be created between the inner liner and the outer utility pipe. The inner liner may be configured to conduct fluid. The method may comprise positioning the communication conduit in the annular space between the inner liner and the outer utility pipe. The communication conduit may be configured to receive one or more components configured to transmit information. In some embodiments, the method may further comprise receiving a fiber optic cable with the communication conduit.

In some embodiments, the method may further comprise filling the annular space between the inner liner and the outer utility pipe with filler material. The filler material may be cementitious and/or may be made from other materials. The outer utility pipe may be formed from steel or concrete or iron or plastic and/or other materials. The inner liner may be formed from steel or concrete or plastic and/or other materials.

In some embodiments, the method may comprise coupling the communication conduit to an inner diameter of the outer utility pipe at a plurality of locations along a length of the outer utility pipe in the annular space. In some embodiments, the method may comprise coupling the communication conduit to the inner diameter of the outer utility pipe by driving an anchor into a wall thickness of the outer utility pipe and strapping the communication conduit to the inner diameter at individual locations along the length of the outer utility pipe using the anchor and a strap. In some embodiments, the method may comprise coupling the communication conduit to the inner diameter of the outer utility pipe at a radial position located toward a ground surface when the outer utility pipe is below ground.

In some embodiments, the method may comprise coupling the outer utility pipe, the inner liner, and the communication conduit with corresponding utility pipes, inner liners, and communication conduits to facilitate extended transmission of information through below ground utility pipes. The communication conduit may comprise fittings at both ends configured to facilitate removable coupling of the communication conduit with additional communication conduits and substantial sealing of the communication conduit to prevent ingress of earthen materials. In some embodiments, the method may comprise forming a port in the outer utility pipe. The port may be configured to allow at least a portion of the communication conduit to pass through and out toward a ground surface.

A third aspect of the present disclosure relates to a system configured to facilitate transmission of information through below ground utility pipes. The system may comprise a utility pipe having an inner diameter surface, an outer diameter surface, and a wall thickness therebetween. The utility pipe may be configured to be placed below ground. The system may comprise a communication conduit positioned in the wall thickness along the inner diameter surface, between the inner diameter surface and the outer diameter surface, and/or at other locations. The communication conduit may be configured to receive one or more components configured to transmit information.

In some embodiments, the system may comprise a channel cut in the wall thickness of the utility pipe. The channel may be configured to receive the communication conduit.

In some embodiments, the communication conduit may be positioned in the wall thickness such that a surface profile of the inner diameter surface or the outer diameter surface of the utility pipe is not interrupted.

In some embodiments, the system may comprise a channel within or otherwise formed in the wall thickness of the utility pipe, without an inner liner or an annular space.

A fourth aspect of the present disclosure relates to a method for facilitating transmission of information through below ground utility pipes. The method may comprise providing a utility pipe having an inner diameter surface, an outer diameter surface, and a wall thickness therebetween. The utility pipe may be configured to be placed below ground. The method may comprise providing a communication conduit positioned in the wall thickness along the inner diameter surface, between the inner diameter surface and the outer diameter surface, and/or at other locations. The communication conduit may be configured to receive one or more components configured to transmit information.

In some embodiments, a channel may be cut in the wall thickness of the utility pipe. The channel may be configured to receive the communication conduit.

In some embodiments, the communication conduit may be positioned in the wall thickness such that a surface profile of the inner diameter surface or the outer diameter surface of the utility pipe is not interrupted.

In some embodiments, the method may comprise forming a channel in the wall thickness of the utility pipe, without an inner liner or an annular space.

These and other aspects of various embodiments of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment of the invention, the structural components illustrated herein are drawn to scale. It is to be expressly understood, however, that the drawings are for the purpose of illustration and description only and are not intended as a definition of the limits of the invention. In addition, it should be appreciated that structural features shown or described in any one embodiment herein can be used in other embodiments as well. As used in the specification and in the claims, the singular form of “a”, “an”, and “the” include plural referents unless the context clearly dictates otherwise.

All closed-ended (e.g., between A and B) and open-ended (greater than C) ranges of values disclosed herein explicitly include all ranges that fall within or nest within such ranges. For example, a disclosed range of 1-10 is understood as also disclosing, among other ranged, 2-10, 1-9, 3-9, etc.

### BRIEF DESCRIPTION OF THE DRAWINGS

For a better understanding of embodiments of the present invention as well as other objects and further features thereof, reference is made to the following description which is to be used in conjunction with the accompanying drawings, where:

FIG. 1 illustrates a system configured to facilitate transmission of information through below ground utility pipes;

FIG. 2 provides a cross-sectional view of an outer utility pipe, a wall thickness, a communication conduit, and/or other components of the system;

FIG. 3 illustrates the communication conduit coupled to an inner surface of the outer utility pipe using an anchor driven into a wall thickness of the outer utility pipe and a strap;

FIG. 4 illustrates an anchor, a strap, and the communication conduit relative to the outer utility pipe, the inner liner, and the location of filler material;

FIG. 5 illustrates a plate configured to be removably coupled to a collar plate to facilitate passage of the communication conduit through the collar plate while maintaining containment of the filler material (in embodiments where filler material is used);

FIG. 6 illustrates the plate relative to the inner liner, the communication conduit, the outer utility pipe, and the annular space or filler material between the inner liner and the outer utility pipe;

FIG. 7 illustrates a wall thickness including a channel configured to receive the communication conduit;

FIG. 8 illustrates a port formed in the outer utility pipe for the communication conduit to pass through on the way to the ground surface;

FIG. 9 illustrates an overhead section view of the system; and

FIG. 10 illustrates a method for facilitating transmission of information through below ground utility pipes.

### DETAILED DESCRIPTION OF EXEMPLARY EMBODIMENTS OF THE INVENTION

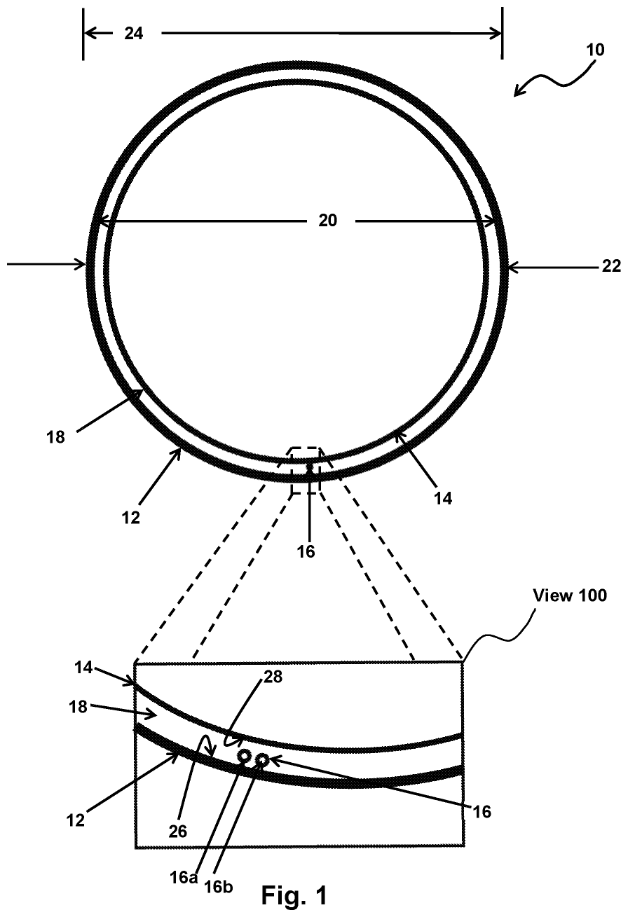

FIG. 1 illustrates a system 10 configured to facilitate transmission of information through below ground utility pipes. In some embodiments, system 10 may include an outer utility pipe 12, an inner liner 14, a communication conduit 16, and/or other components. In some embodiments, system 10 does not include an inner liner. Extensive networks of below ground utility pipes conduct liquid and gas under and between most cities. These pipes typically transport fluid including liquid, gas, and other fluids. For example, these pipes may conduct, water, natural gas, oil, etc. Below ground utility pipes are often dedicated to transporting liquid or gas. They are not configured for other purposes.

System 10 takes advantage of networks of below ground utility pipes. System 10 provides additional functionality for these pipes. Instead of merely conducting water or natural gas, for example, system 10 facilitates transmission of information through a utility pipe (and/or network of utility pipes). System 10 may be configured as a standalone system (e.g., a pre-fabricated single pipe) configured to be coupled with an existing network of other pipes, and/or system 10 may be part of a retrofit or other repair or upgrade, of an existing pipe or pipe network. For example, aging below ground utility pipes are often repaired. When the below ground utility pipes need to be repaired or replaced, system 10 may be configured such that the repair or replacement includes, in some embodiments, inner liner 14 installed in an existing outer utility pipe 12, creating an annular space 18 between the outer utility pipe 12 under repair and inner liner 14. System 10 may include communication conduit 16 positioned in annular space 18 between inner liner 14 and outer utility pipe 12. In some embodiments, system 10 may include outer utility pipe 12 have a channel formed on an inner diameter surface thereof (e.g., without inner liner 14 or annular space 18). Communication conduit 16 may be configured to receive one or more components configured to transmit information such as fiber optic cables or other components. By connecting a plurality of pipes including system 10 to each other, an extensive communication network may be created, in space already used for other purposes. No additional space, digging, construction, etc. is necessary to create the communication network. This communication path is created using space that would otherwise be wasted. The relining (for example) of a pipe creates an opportunity to add a conduit/communication path for very little added cost and effort when compared to traditional fiber installation. Physical security of the communication fiber is also improved as it becomes part of the pipe system.

It should be noted that system 10 is described with respect to below ground utility pipes, and specifically water pipes. This is not intended to be limiting. System 10 may be applied to any pipe, below ground or above ground. It addition, the term pipe is not intended to be limiting. System 10 may be applied in other structures where space is created between an inner layer and an outer later, and those structures are coupled to form a network.

FIG. 1 provides a cross-sectional view of outer utility pipe 12, inner liner 14, communication conduit 16, and/or other components of a first embodiment of system 10. Outer utility pipe 12 may be a pipe configured, or once configured, to conduct fluid. (In the illustration shown in FIG. 1, fluid flow would be into or out of the page.) In some embodiments, pipe 12 may be specifically designed to be the outer pipe in a structure similar to and/or the same as the structure in system 10. In some embodiments, pipe 12 may be a new pipe. In some embodiments, pipe 12 may be an aging pipe, a pipe in need of repair, a pipe undergoing a retrofit, and/or other pipes. Pipe 12 may be, or configured to be, buried underground. In some embodiments, pipe 12 may be formed from steel, concrete, iron, plastic, and/or other materials. Pipe 12 may be a cylindrical tube or have other shapes. Pipe 12 is illustrated in FIG. 1 as having a circular cross section. However, this is not intended to be limiting. Pipe 12 may have any shape that allows it to function as described herein.

Pipe 12 may have an inside diameter 20, and outside diameter 22, a length (not shown in FIG. 1) and/or other dimensions. In some embodiments, outside diameter 22 may range between about 8 inches and about 264 inches. In some embodiments, inside diameter 20 may range between about 6 inches and about 252 inches. In some embodiments, the length of pipe 12 may range between about 10 feet and about 100 miles (e.g., pipe 12 may be representative of two or more pipes 12 that have been coupled. It should be noted that these ranges are not intended to be limiting. For example, the dimensions of pipe 12 may be scaled up or down, or the dimensions of pipe 12 may be changed in other ways. Diameter 20, diameter 22, and the length of pipe 12 may be configured such that pipe 12 performs as described herein.

Inner liner 14 may be a pipe configured to conduct fluid. For example, inner liner 14 may be configured to conduct water and/or other fluids. In some embodiments, inner liner 14 may be formed from steel, concrete, plastic, and/or other materials. Inner liner 14 may be a cylindrical tube or have other shapes. Like pipe 12, inner liner 14 is illustrated in FIG. 1 as having a circular cross section. However, this is not intended to be limiting. Inner liner 14 may have any shape that allows it to function as described herein. For example, the shape and size of inner liner 14 may correspond to the shape and size of pipe 12 so that inner liner 14 may be inserted or otherwise positioned inside pipe 12. Inner liner 14 may have an outer diameter 24. Outer diameter 24 may be configured to fit within inside diameter 20 of pipe 12. Outer diameter 24 may be smaller than the inside diameter 20, for example. In some embodiments, outer diameter 24 of inner liner 14 may range between about 6 inches and about 248 inches, depending on the dimensions of inside diameter 20. This is not intended to be limiting.

Inner liner 14 may be positioned inside outer utility pipe 12 such than an annular space 18 is created between inner liner 14 and outer utility pipe 12. Annular space 18 may be a ring-shaped (this is not intended to be limiting) space located between pipe 12 and inner liner 14. Annular space 18 may extend along the lengths of inner liner 14 and pipe 12 inside pipe 12. Annular space 18 may be created between inner liner 14 and pipe 12 using spacers positioned between inner liner 14 and pipe 12 at various locations along the lengths of inner liner 14 and pipe 12. In some embodiments, the spacers may be coupled to inner liner 14, pipe 12 and/or other components of system 10. In some embodiments, the spacers may be placed between inner liner 14 and pipe 12 but not coupled to either component. In some embodiments, annular space 18 may be created between inner liner 14 and pipe 12 using one or more collars and/or other guiding components coupled to inner liner 14 and/or pipe 12. In some embodiments, the one or more collars and/or other guiding components may be placed along the lengths of inner liner 14 and pipe 12 within annular space 18. In some embodiments, annular space 18 may be created between inner liner 14 and pipe 12 using other methods.

Communication conduit 16 may be positioned in annular space 18 between inner liner 14 and outer utility pipe 12. Communication conduit 16 may be configured to receive one or more components configured to transmit information. In some embodiments, the one or more components communication conduit 16 is configured to receive comprise a fiber optic cable, electrically conductive power cable, electrically conductive communication cable, drawcords, and/or other components. As shown in view 100 of FIG. 1, in some embodiments, communication conduit 16 may comprise two or more individual communication conduits. View 100 is an enlarged view of a portion of system 10 shown in FIG. 1. In view 100, two (as an example) individual communication conduits 16a and 16b are labeled. Communication conduits 16a and 16b may be located in proximity to each other (e.g., as shown in view 100) within annular space 18, or in different locations within annular space 18. In some embodiments, the two or more individual communication conduits may be coupled to each other, an inner surface 26 of pipe 12, an outer surface of 28 of inner liner 14, and/or other components. In some embodiments, individual communication conduits 16 (e.g., 16a and 16b) may be located within a housing or other enclosure configured to hold individual communication conduits 16. For example, communication conduit 16, and/or individual communication conduits 16a and 16b, may be wrapped with fiberglass tape, and/or have other housings or enclosures.

In some embodiments, system 10 comprises filler material (not labeled) that fills annular space 18 between inner liner 14 and outer utility pipe 12. The filler material may be sprayed, poured, injected, and/or otherwise inserted into annular space 18 to fill annular space 18. In some embodiments, the filler material may be inserted into annular space 18 after communication conduit 16 has been placed in annular space 18. For example, cement filler material may be sprayed into annular space 18 and cover a communication conduit 16 that had been previously positioned inside annular space 18.

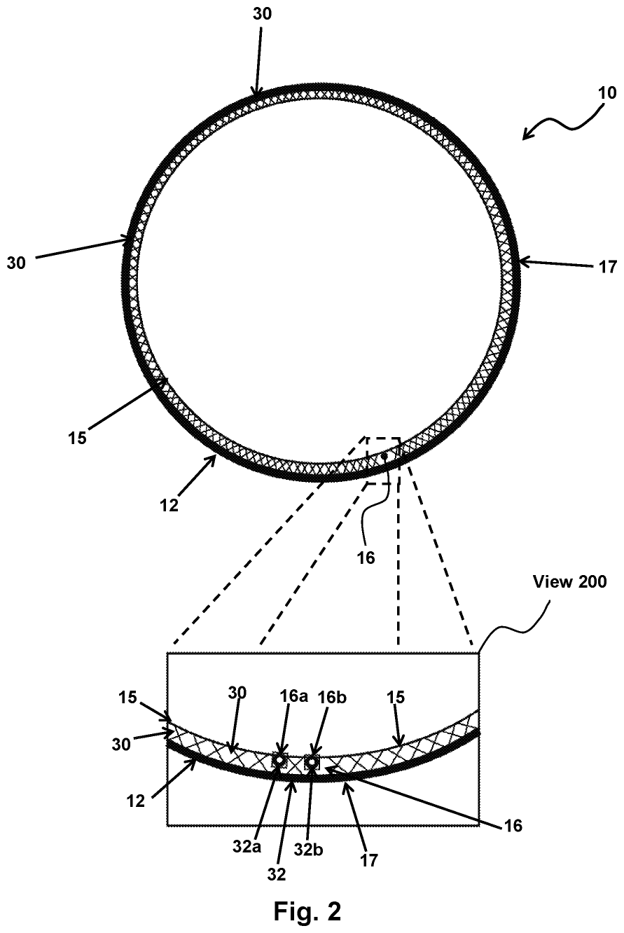

In some embodiments, a second embodiment of system 10 comprises a utility pipe 12 having an inner diameter surface 15, an outer diameter surface 17, and a wall thickness 30 therebetween. Wall thickness 30 is illustrated in FIG. 2, which includes view 200. View 200 is an enlarged view of a portion of system 10 shown in FIG. 2. FIG. 2 (and view 200) provides a cross-sectional view of the outer surface 17 of utility pipe 12, inner surface 15, communication conduit 16, and/or other components of system 10. In some embodiments, wall thickness 30 may comprise cement, grout, concrete, and/or other materials.

In some embodiments, wall thickness 30 may comprise one or more channels 32 configured to receive communication conduit(s) 16. View 200 illustrates two channels 32a and 32b, but this is not intended to be limiting. In some embodiments, channels 32 may be formed along inner surface 15 of pipe 12, within wall thickness 30, and/or in other locations. In some embodiments, a cross-sectional shape of channels 32 may correspond to a shape of communication conduits 16, a housing or enclosure holding communication conduits 16, and/or correspond to other components of system 10. In some embodiments, the cross-sectional shape of channels 32 may not correspond to a shape of communication conduits 16. For example, as shown in view 200, channels 32a and 32b have a rectangular or square cross-sectional shape, while communication conduits 16a and 16b have a circular cross section.

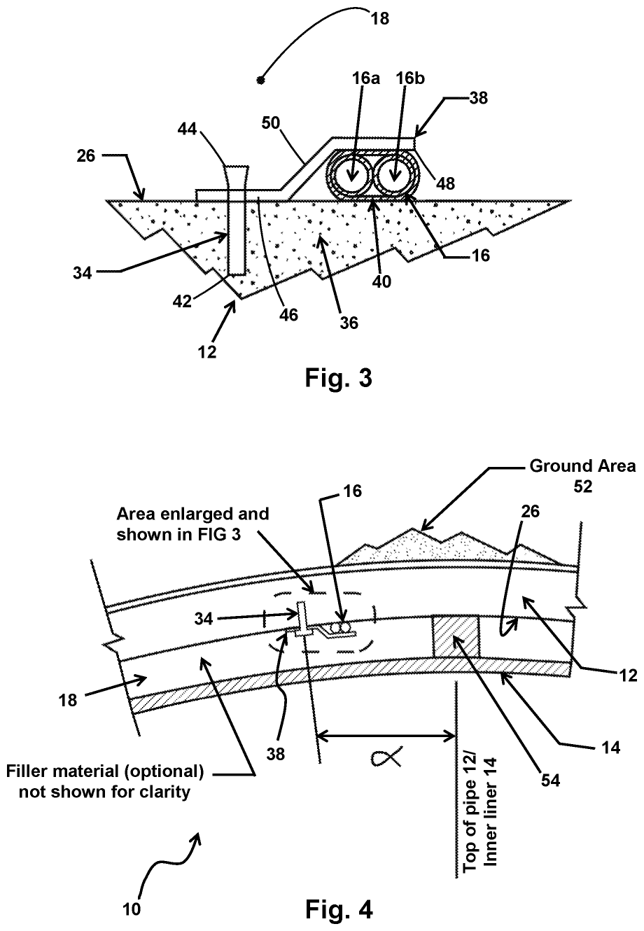

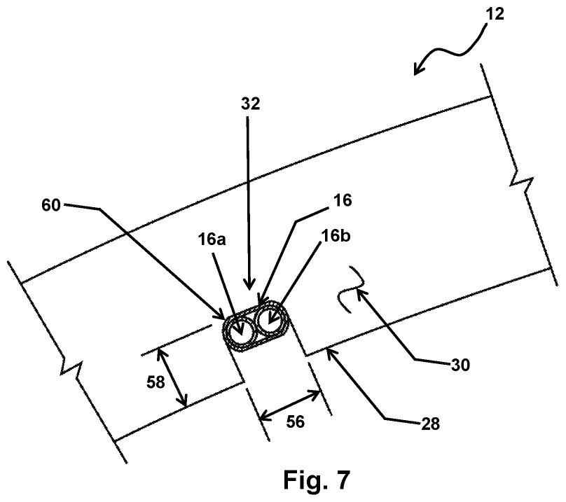

FIG. 3-6 provide additional views of outer utility pipe 12, inner liner 14, communication conduit 16, and/or other components of the first embodiment of system 10. FIG. 7 provides an additional view of outer utility pipe 12, wall thickness 30, a channel 32, communication conduits 16, and/or other components of the second embodiment of system 10. (In the illustrations shown in FIG. 3-7, fluid flow through inner liner 14 (e.g., FIG. 3-6) and/or outer utility pipe 12 (FIG. 7) would be into or out of each page.)

FIG. 3 and FIG. 4 illustrate communication conduit 16 coupled to inner surface 26 (e.g., along inner diameter 20 shown in FIG. 1) of outer utility pipe 12. Communication conduit 16 may be coupled to inner surface 26 of pipe 12 at a plurality of locations along a length of inner surface 26 of pipe 12 in annular space 18. Specifically, FIG. 3 illustrates an individual location where communication conduit 16 is coupled to inner surface 26 of outer utility pipe 12 using an anchor 34 driven into a wall thickness 36 of outer utility pipe 12 and a strap 38. The structure shown in FIG. 3 may be repeated at individual locations along the length of outer utility pipe 12. In the example shown in FIG. 3, communication conduit 16 includes an enclosure 40 that houses communication conduits 16a and 16b.

Anchor 34 may be and/or include a pin and/or other anchoring components for example. Anchor 34 may have a first end 42 configured to be driven into pipe 12. Anchor 34 may have a second, opposite, end 44 configured to hold strap 38 against pipe 12. In some embodiments, end 42 may be narrower (e.g., have a smaller cross sectional area, a smaller diameter, etc.) than end 44 to facilitate driving anchor 34 into pipe 12. In some embodiments, end 44 may be wider (e.g., have a larger cross sectional area, a larger diameter, etc.) than end 42 to facilitate holding strap 38 against pipe 12. In some embodiments, anchor 34 may be driven through strap 38 and/or an orifice in strap 38 and into wall thickness 36 of pipe 12, for example. In some embodiments, anchor 34 may include two or more anchors 34. For example, this may include one anchor 34 driven into pipe 12 on either side of communication conduit 16 (not shown in FIG. 3).

Strap 38 may be configured to hold communication conduit 16 in annular space 18. In some embodiments, strap 38 may be configured to hold communication conduit 16 against inner surface 26 of pipe 12 in annular space 18. In some embodiments, strap 38 may be and/or include a metallic strap, a fabric strap, and/or other straps. In some embodiments, strap 38 may be a substantially planar strap, a cable strap, and/or other straps. In some embodiments, strap 38 may be anchored by anchor 34 at one or more locations (e.g., ends) along strap 38. In some embodiments, as shown in FIG. 3, strap 38 may include one or more portions 46 in contact with pipe 12. Strap 38 may include other portions 48 in contact with communication conduit 16, transition portions 50 coupling portions 46 and 48, and/or other portions. In some embodiments, portion 50 and/or other portions of strap 38 may form an angle with surface 26 of pipe 12 to accommodate a shape of communication conduit 16. For example, portion 50 may form steeper angle relative to surface 26 responsive to communication conduit 16 being larger, and portion 50 may form a shallower angle relative to surface 26 response to communication conduit being smaller. In some embodiments, portion 50 may be made longer or shorter (at the same angle) to accommodate a size of communication conduit 16.

FIG. 4 illustrates a wider view of the components shown in FIG. 3. FIG. 4 illustrates anchor 34, strap 38, and communication conduit 16 relative to pipe 12, inner liner 14, and the location of (optional) filler material in annular space 18. As shown in FIG. 4, annular space 18 may be formed by one or more spacers 54 positioned between inner liner 14 and pipe 12. Spacers 54 may be positioned at any locations between inner liner 14 and pipe 12 that allow system 10 to function as described herein. For example, one or more spacers 54 provide sufficient support to inner liner 14 to create and/or maintain annular space 18, while also providing an open pathway along pipe 12 and inner liner 14 for communication conduit 16. FIG. 4 illustrates spacer 54 as a block with a rectangular or square cross section (extending through the page along inner liner 14 and tube 12), but this is not intended to be limiting.

FIG. 4 illustrates anchor 34, strap 38, and communication conduit 16 in annular space 18, between pipe 12 and inner liner 14. Inner liner 14 and pipe 12 are shown within ground area 52. As shown in FIG. 4, communication conduit 16 may be coupled to inner surface 26 (along the inner diameter) of outer utility pipe 12 at a radial position a that corresponds to anchor 34, communication conduit 16, and/or other components of system 10. Radial position a may be located toward a ground surface (e.g., toward a top of pipe 12) when the outer utility pipe 12 is within ground area 52 (e.g., below ground), or in other locations. In the example shown in FIG. 4, radial position a of anchor 34 is located at about 22.5° from a vertical position that corresponds to a top of pipe 12 and inner liner 14 when system 10 is buried (or otherwise positioned) beneath a ground surface. This is just one example of many possible radial positions for anchor 34 and/or communication conduit 16. However, positioning communication conduit 16 at a radial position located toward a ground surface when pipe 12 is within ground are 52 may facilitate easier access to communication conduit 16 from a ground surface, and/or extension of communication conduit 16 up to a ground surface.

In some embodiments, communication conduit 16 comprises one or more fittings at one or both ends of communication conduit 16 (and/or one or both ends of other components of system 10 such as pipe 12, inner liner 14, etc.) configured to facilitate removable coupling of communication conduit 16 with additional communication conduits, substantial sealing of communication conduit 16 and/or an area around communication conduit 16 to prevent ingress of earthen materials or liquid, or for other purposes. The one or more fittings may include gaskets, O-rings, plates, clamps, adhesive, interlocking elements, seals, and/or other fittings.

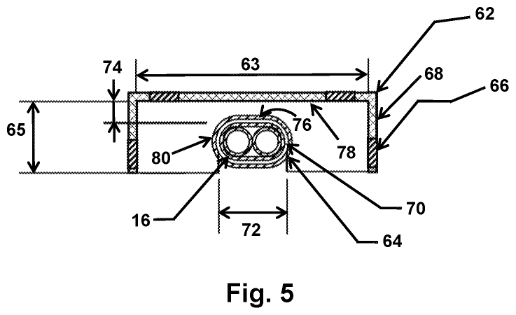

By way of a non-limiting example, FIG. 5 illustrates a plate 62 that may be removably coupled to an end 64 of communication conduit 16. Plate 62 may facilitate sealing (optional) filler material (e.g., grout) in position when positioned against a collar plate (e.g., as shown in a figure described below), substantial sealing of communication conduit 16 and/or an area around communication conduit 16 to prevent ingress of earthen materials or liquid, or plate 62 may be used for other purposes. Plate 62 may have a length 63 ranging between about 6 inches and about 8 inches. Plate 62 may have a width 65 ranging between about 1 inch and about 2 inches. Plate 62 may have a thickness (not shown in FIG. 5) ranging between about ⅛ inch and about ⅜ inch. Plate 62 may include a channel 70 configured to receive communication conduit 16. Channel 70 may have a “U” shape and/or other shapes. Channel 70 may open toward a side of plate 62 along length 63, for example, and have a channel width 72 ranging between about 0.5 inches and about 3 inches. Channel 70 may have a depth defined by a distance 74 between an end 76 of channel 70 and a side 78 of plate 62 opposite channel width 72. Rounded corners 80 of channel 70 may have a radius that corresponds to a shape of communication conduit 16. These shapes and dimensions are not intended to be limiting. The shape and size of channel 70 may correspond to communication conduit 16 and have any size or shape that allows system 10 (FIG. 1) to function as described herein.

In some embodiments, plate 62 may be formed from steel, other metals, and/or other materials. In some embodiments, plate 62 may be welded to inner liner 14 (not shown in FIG. 5) and/or other components of system 10 at one or more weld locations 66. Weld locations 66 are shown along an outside edge 68 of plate 62 in FIG. 5, but this is not intended to be limiting. There may be any number of weld locations 66, at any locations on plate 62, which allow plate 62 to function as described herein. In some embodiments, an adhesive, sealing materials, and/or other substances may be applied along edges of plate 62, at or near communication conduit 16, and/or in other locations to couple pate 62 to one or more other components of system 10 (FIG. 1); prevent ingress of liquid, earthen materials, and/or other materials; and/or for other purposes.

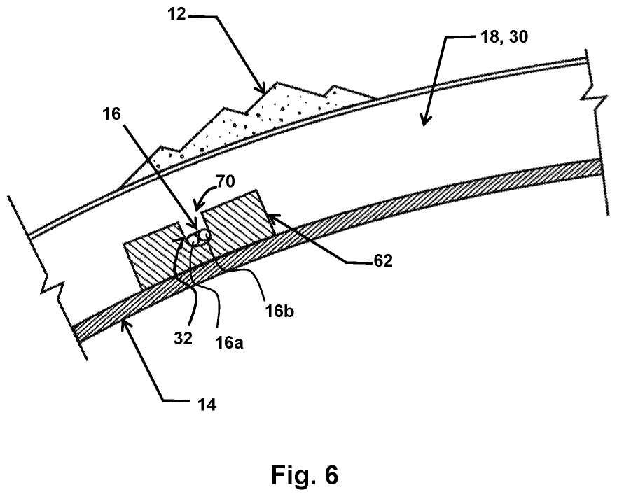

FIG. 6 illustrates a position of plate 62 relative to inner liner 14, communication conduit 16, pipe 12, and annular space 18, according to one or more embodiments. In some embodiments, annular space 18 may be filled with filler material. In some embodiments (e.g., without inner liner 14 or annular space 18 as described herein), a channel may be cut into a wall thickness 30 of pipe 12. In some embodiments, the present system includes a collar plate (not specifically labeled in FIG. 6) positioned at an end of pipe 12 (e.g., covering annular space 18, filler material, or wall thickness 30 depending on the embodiment). In some embodiments, plate 62 may be coupled (e.g., welded) to this collar plate. As show in FIG. 6, channel 70 is positioned to open toward pipe 12. Channel 70 and the collar plate (and/or the filler material or wall thickness 30), as an example shown here, may cooperate to hold communication conduit 16 as shown in FIG. 6. Plate 62 may be positioned such that channel 70, opening toward pipe 12, receives communication conduit 16. In this example, the collar plate and channel 70 (opening in a direction toward pipe 12) cooperate to hold communication conduit 16 in place.

As described above, in some embodiments, wall thickness 30 may comprise one or more channels 32 configured to receive communication conduit(s) 16. FIG. 7 illustrates wall thickness 30 including a channel 32. Channel 32 may be configured to receive communication conduit 16. FIG. 7 illustrates wall thickness 30 as cementious ring, for example, but this is not intended to be limiting. In some embodiments, channel 32 may be formed along a surface 28 of pipe 12 (e.g., as shown in FIG. 7), and/or in other locations. In some embodiments, a cross-sectional shape of channels 32 may correspond to a shape of communication conduits 16, a housing or enclosure holding communication conduits 16, and/or correspond to other components of system 10. For example, channel 32 shown in FIG. 7 has a width 56 and a depth 58 sized such that channel 32 is configured to receive communication conduit 16. In some embodiments, width 56 may range between about 0.5 inches and about 3 inches. In some embodiments, depth may range between about 0.5 inches and about 1 inch. These dimensions are examples only and are not intended to be limiting. Width 56 and/or depth 58 may have any dimensions that channel 32 to receive or otherwise accommodate communication conduit 16. In some embodiments, channel 32 may include other features such as rounded corners 60 and/or other features that correspond to a shape and/or other features of communication conduit 16. However, in some embodiments, the cross-sectional shape of channels 32 may not correspond to a shape of communication conduits 16 (e.g., as described above). In some embodiments, channels 32 may be molded into wall thickness 30, sawed into wall thickness 30, cut into wall thickness 30, and/or formed in other ways.

As described above, outer utility pipe 12, inner liner 14, communication conduit 16, and/or other components of system 10 (FIG. 1) are configured to couple with corresponding utility pipes, inner liners, and communication conduits to facilitate extended transmission of information through below ground utility pipes, and/or other pipes. In some embodiments, outer utility pipe 12 comprises a port configured to allow at least a portion of communication conduit 16 to pass through and out toward a ground surface.

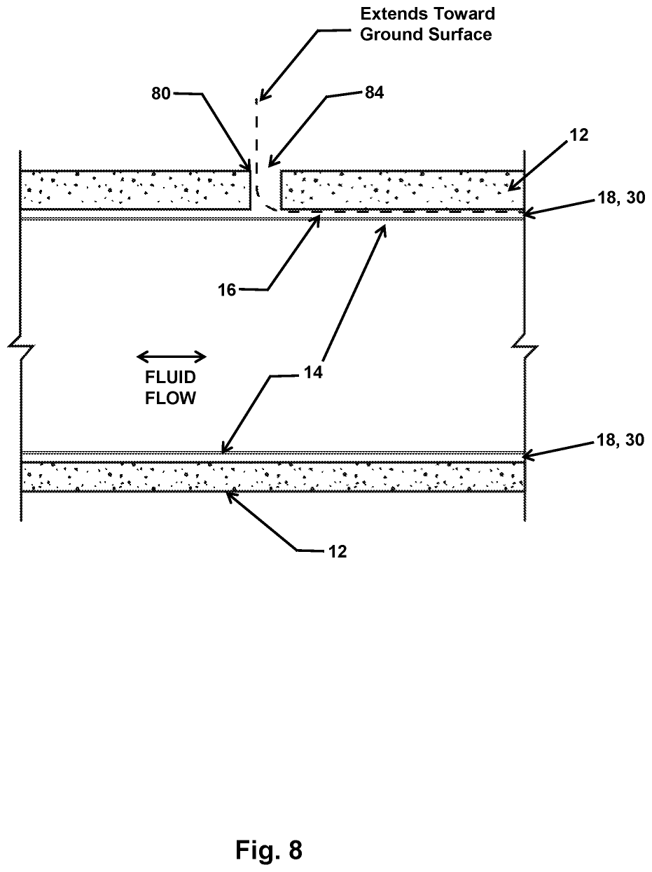

FIG. 8 illustrates a port 82 formed in pipe 12. Port 82 may be a hole, an opening, a gap, and/or other orifices formed in pipe 12. Port 82 may be drilled, sawed, formed during manufacture of pipe 12, and/or created in other ways. Port 82 may have a size and shape configured to allow communication conduit 16 to pass through port 82. As shown in FIG. 8, communication conduit 16 may extend through annular space 18 (or filler material or wall thickness 30 depending on the embodiment) along the length of pipe 12. Port 82 is formed in pipe 12 at a location 84. Location 84 may correspond to surface components (e.g., a utility box—a “pull box”—and/or other components) configured to receive communication conduit 16 and/or other locations. Communication conduit 16 (or at least a portion of communication conduit 16) may pass through port 82 at location 84 and extend up to the surface components, for example. It should be noted that fluid flow in FIG. 8 might be from right to left, or left to right, for example.

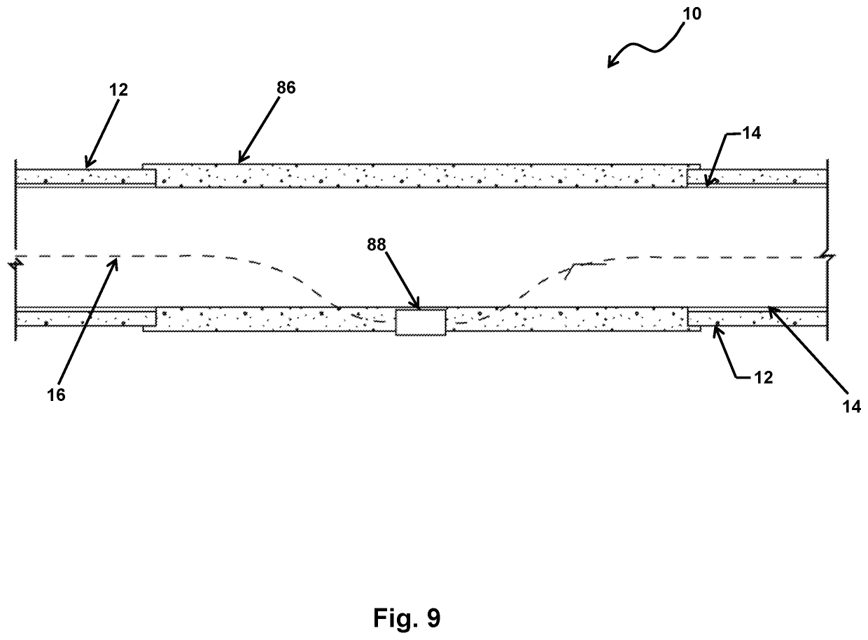

FIG. 9 illustrates an overhead section view of system 10. FIG. 9 illustrates outer utility pipe 12, inner liner 14 (in this example embodiment), and communication conduit 16. In FIG. 9, pipe 12 and inner liner 14 are shown in a concrete encasement 86, as an example. FIG. 9 also illustrates a utility box 88 (or pull box) that receives communication conduit 16. FIG. 9 illustrates communication conduit 16 running along a top side (FIG. 9 is a view from above) of inner liner 14 between inner liner 14 and pipe 12 (in section view). Communication conduit 16 may extend through pipe 12 at a port (such as port 80 shown in FIG. 8) and up (e.g., out of the page as drawn in FIG. 9) toward utility box 88. Utility box 88 may be located at or near a ground surface, for example, so that communication conduit 16 may be accessed by utility providers and/or other users. As in FIG. 8, it should be noted that fluid flow in FIG. 9 might be from right to left, or left to right, for example.

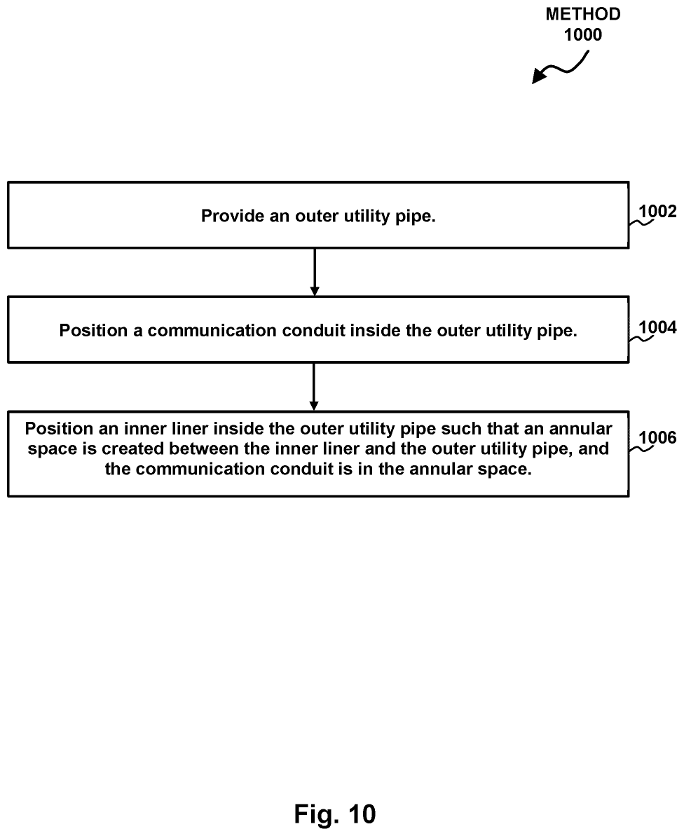

FIG. 10 illustrates a method 1000 for facilitating transmission of information through below ground utility pipes. The operations of method 1000 presented below are intended to be illustrative. In some embodiments, method 1000 may be accomplished with one or more additional operations not described, and/or without one or more of the operations discussed. Additionally, the order in which the operations of method 1000 are illustrated in FIG. 10 and described below is not intended to be limiting.

At an operation 1002, an outer utility pipe is provided. The outer utility pipe may have a first diameter, for example. The outer utility pipe may be buried below ground and/or be positioned in other locations. In some embodiments, operation 1002 may be performed by an outer utility pipe that is the same as or similar to outer utility pipe 12 (shown in FIG. 1 and described herein).

At an operation 1004, a communication conduit is positioned inside the outer utility pipe. The communication conduit may be configured to receive one or more components configured to transmit information. In some embodiments, operation 1004 may further comprise receiving a fiber optic cable with the communication conduit.

In some embodiments, operation 1004 may include operation 1004a or 1004b. In some embodiments, operation 1004a may include positioning a communication conduit in a channel in the wall thickness between the inner diameter surface and the outer diameter surface of the utility pipe along the inner diameter surface. In some embodiments, operation 1004a may include cutting the channel in the wall thickness of the outer utility pipe such that the channel is configured to receive the communication conduit. In some embodiments, a cross-sectional shape of the channel may correspond to a shape of the communication conduit, a housing or enclosure holding the communication conduit, and/or correspond to other components.

In some embodiments, operation 1004b may comprise coupling the communication conduit to an inner diameter of the outer utility pipe at a plurality of locations along a length of the outer utility pipe. In some embodiments, operation 1004b may comprise coupling the communication conduit to the inner diameter of the outer utility pipe by driving an anchor into a wall thickness of the outer utility pipe and strapping the communication conduit to the inner diameter at individual locations along the length of the outer utility pipe using the anchor and a strap. In some embodiments, operation 1004b may comprise coupling the communication conduit to the inner diameter of the outer utility pipe at a radial position located toward a ground surface when the outer utility pipe is below ground, for example.

In embodiments that include operation 1004b, at an operation 1006, an inner liner is positioned inside the outer utility pipe such that an annular space is created between the inner liner and the outer utility pipe, and the communication conduit is in the annular space. The inner liner may have a second diameter. The second diameter may be smaller than the first diameter. The inner liner may be configured to conduct fluid and/or may be configured for other purposes. In some embodiments, the operation 1006 may further comprise filling the annular space between the inner liner and the outer utility pipe with filler material. The filler material may be cement, grout, and/or other materials. The outer utility pipe may be formed from iron, steel, plastic, or concrete, and/or other materials. The inner liner may be formed from steel, plastic, concrete, and/or other materials for example. In some embodiments, operation 1006 is performed by an inner liner the same as or similar to inner liner 14 (shown in FIG. 1 and described herein).

In some embodiments, the filler material may be a grout ring, for example, but this is not intended to be limiting.

In some embodiments, operations 1004 and/or 1006 may be performed by a communication conduit that is the same as or similar to communication conduit 16 (shown in FIG. 1 or 2, and described herein).

In some embodiments, method 1000 may comprise coupling the outer utility pipe, the inner liner, and the communication conduit with corresponding utility pipes, inner liners, and communication conduits to facilitate extended transmission of information through below ground utility pipes. The communication conduit may comprise fittings at both ends configured to facilitate removable coupling of the communication conduit with additional communication conduits and substantial sealing of the communication conduit to prevent ingress of earthen materials. In some embodiments, method 1000 may comprise forming a port in the outer utility pipe. The port may be configured to allow at least a portion of the communication conduit to pass through and out toward a ground surface, for example.

Although the disclosure has been described in detail for the purpose of illustration based on what is currently considered to be the most practical and preferred embodiments, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A system configured to facilitate transmission of information through below ground utility pipes, the system comprising:
an outer utility pipe having a first diameter, the outer utility pipe configured to be placed below ground;
an inner liner having a second diameter, the second diameter smaller than the first diameter, the inner liner positioned inside the outer utility pipe such than an annular space is created between the inner liner and the outer utility pipe, the inner liner configured to conduct fluid; and
a communication conduit positioned in the annular space between the inner liner and the outer utility pipe, the communication conduit configured to receive one or more components configured to transmit information.

2. The system of claim 1, wherein the one or more components the communication conduit is configured to receive comprise a fiber optic cable.

3. The system of claim 1, wherein the outer utility pipe is formed from iron, steel, plastic, or concrete.

4. The system of claim 1, wherein the inner liner is formed from steel, plastic, or concrete.

5. The system of claim 1, wherein the communication conduit is coupled to an inner diameter of the outer utility pipe at a plurality of locations along a length of the outer utility pipe in the annular space.

6. The system of claim 5, wherein the communication conduit is coupled to the inner diameter of the outer utility pipe using an anchor driven into a wall thickness of the outer utility pipe and a strap at individual locations along the length of the outer utility pipe.

7. The system of claim 6, wherein the communication conduit is coupled to the inner diameter of the outer utility pipe at a radial position located toward a ground surface when the outer utility pipe is below ground.

8. The system of claim 1, wherein the outer utility pipe, the inner liner, and the communication conduit are configured to be coupled with corresponding utility pipes, inner liners, and communication conduits to facilitate extended transmission of information through below ground utility pipes.

9. The system of claim 1, wherein the communication conduit comprises fittings at both ends of the communication conduit configured to facilitate removable coupling of the communication conduit with additional communication conduits and substantial sealing of the communication conduit to prevent ingress of earthen materials into the communication conduit.

10. The system of claim 1, wherein the outer utility pipe comprises a port configured to allow at least a portion of the communication conduit to pass through and out toward a ground surface.

11. A method for facilitating transmission of information through below ground utility pipes, the method comprising:
providing an outer utility pipe having a first diameter, the outer utility pipe being configured to be below ground;
positioning a communication conduit inside the outer utility pipe; and
positioning an inner liner inside the outer utility pipe, the inner liner having a second diameter, the second diameter smaller than the first diameter, the inner liner positioned inside the outer utility pipe such than an annular space is created between the inner liner and the outer utility pipe, the inner liner configured to conduct fluid;
wherein the communication conduit is in the annular space between the inner liner and the outer utility pipe, the communication conduit configured to receive one or more components configured to transmit information.

12. The method of claim 11, further comprising receiving a fiber optic cable with the communication conduit.

13. The method of claim 11, wherein the outer utility pipe is formed from iron, steel, plastic, or concrete.

14. The method of claim 11, wherein the inner liner is formed from steel, plastic, or concrete.

15. The method of claim 11, further comprising coupling the communication conduit to an inner diameter of the outer utility pipe at a plurality of locations along a length of the outer utility pipe in the annular space.

16. The method of claim 15, further comprising coupling the communication conduit to the inner diameter of the outer utility pipe by driving an anchor into a wall thickness of the outer utility pipe and strapping the communication conduit to the inner diameter at individual locations along the length of the outer utility pipe using the anchor and a strap.

17. The method of claim 16, further comprising coupling the communication conduit to the inner diameter of the outer utility pipe at a radial position located toward a ground surface when the outer utility pipe is below ground.

18. The method of claim 11, further comprising coupling the outer utility pipe, the inner liner, and the communication conduit with corresponding utility pipes, inner liners, and communication conduits to facilitate extended transmission of information through below ground utility pipes.

19. The method of claim 11, wherein the communication conduit comprises fittings at both ends of the communication conduit configured to facilitate removable coupling of the communication conduit with additional communication conduits and substantial sealing of the communication conduit to prevent ingress of earthen materials into the communication conduit.

20. The method of claim 11, further comprising forming a port in the outer utility pipe, the port configured to allow at least a portion of the communication conduit to pass through and out toward a ground surface.

21. A system configured to facilitate transmission of information through below ground utility pipes, the system comprising:
a utility pipe having an inner diameter surface, an outer diameter surface, and a wall thickness therebetween, the utility pipe configured to be placed below ground; and
a communication conduit positioned in a channel in the wall thickness between the inner diameter surface and the outer diameter surface along the inner diameter surface, the communication conduit configured to receive one or more components configured to transmit information.

22. The system of claim 21, further comprising the channel in the wall thickness of the outer utility pipe, the channel configured to receive the communication conduit.

23. The system of claim 22, wherein the wall thickness is cementitious.

24. The system of claim 21, wherein the outer utility pipe and the communication conduit are coupled with corresponding utility pipes and communication conduits to facilitate extended transmission of information through below ground utility pipes.

25. The system of claim 21, wherein the communication conduit is positioned in the wall thickness such that a surface profile of the inner diameter surface or the outer diameter surface of the utility pipe is not interrupted.

26. A method for facilitating transmission of information through below ground utility pipes, the method comprising:
providing a utility pipe having an inner diameter surface, an outer diameter surface, and a wall thickness therebetween, the utility pipe configured to be placed below ground; and
positioning a communication conduit in a channel in the wall thickness between the inner diameter surface and the outer diameter surface along the inner diameter surface, the communication conduit configured to receive one or more components configured to transmit information.

27. The method of claim 26, further comprising cutting the channel in the wall thickness of the outer utility pipe, the channel configured to receive the communication conduit.

28. The method of claim 27, wherein the wall thickness is cementitious.

29. The method of claim 26, further comprising coupling the outer utility pipe and the communication conduit with corresponding utility pipes and communication conduits to facilitate extended transmission of information through below ground utility pipes.

30. The method of claim 26, further comprising positioning the communication conduit in the wall thickness such that a surface profile of the inner diameter surface or the outer diameter surface of the utility pipe is not interrupted.
